(19) United States
(12) Patent Application Publication
(10) Pub. No.: US 2014/0311226 A1
(43) Pub. Date: Oct. 23, 2014

(54) RHEOMETER WITH RADIANT HEATING OF SAMPLE FLUID

(71) Applicant: Brookfield Engineering Laboratories, Inc., Middleboro, MA (US)

(72) Inventors: Christopher J Murray, Raynham, MA (US); James A Salomon, Providence, RI (US)

(73) Assignee: Brookfield Engineering Laboratories, Inc., Middleboro, MA (US)

(21) Appl. No.: 14/211,973

(22) Filed: Mar. 14, 2014

Related U.S. Application Data
(60) Provisional application No. 61/792,612, filed on Mar. 15, 2013.

(51) Int. Cl. G01N 11/00; B01L 7/00

(52) U.S. Cl. CPC G01N 11/00; B01L 7/00; G01N 2011/0093
USPC 73/54.42; 392/418; 219/432

(57) ABSTRACT

A rheometer instrument with radiant heating of sample fluid with use of emissive/absorbing spaced surfaces of a sample container and an interior surface and of a chamber surrounding the sample container in part that is in a heating unit and controls for reliably reaching and maintaining target sample temperatures. The sample fluid can be pressurized.

### RELATED APPLICATION

This application claims the benefit of priority to U.S. Provisional Application No. 61/792,612, filed on Mar. 15, 2013, the entire contents of which are incorporated herein by reference for all purposes.

### BACKGROUND

The present invention relates to rheometers and more particularly to couette rheometers for testing rheological properties of a fluid sample (liquid, slurry, gel or powder mix, hereafter “fluid”) in a sample cup.

Several forms of couette rheometer are extant in the prior art including the Brookfield Engineering Laboratories (assignee of the present invention) models PVS and Thermosel. In all of these, a spindle is contained within a cup filled partially with the fluid sample material, typically a liquid and a relative rotation is established between the cup and spindle, driving one while the other is a fixed sensing element and heating the sample by conduction from a heat source to and through the cup. In one form, the cup is rotated and the spindle is at the end of a sensing shaft and fixed to ground via a torque transducer for limited angular deflection that can occur through the sample fluid. In another form, the spindle is driven and the cup is fixed.

Generally, the prior art is unable to provide a stable heating of the sample material to enable rheology measurements at a stably maintained elevated target temperature, e.g., 260° C., or higher. There is therefore a need to overcome this limitation.

### SUMMARY

A rheometer instrument with a rheometer unit insertable into and removable from a heating unit is provided along with the latter unit, constructed to provide a heating of the sample cup portion of the rheometer unit by radiant heating—as a replacement for traditional heated liquid bath of water or alcohol (e.g. glycol) solution) from the inner surface diameter of a cup well receiving well (chamber) within a heating block of the heating unit. The chamber has an inner surface that substantially surrounds and is in closely opposing relation to the outer diameter surface of the sample cup of the rheometer unit). The two opposing surfaces are coated or otherwise constructed or modified to produce emissive/absorption surfaces, typically with the inner diameter surface of the heating unit chamber having a smooth, machined surface spray painted with fiat black high temperature silicone based paint and a sample cup outer diameter being sand blasted with 100-180 grit and coated with a flat/matte ceramic coating. Reference to inner and/or outer “diameter surfaces” herein can include flat or other non-circular shapes as well as circular shapes, e.g. where the sample cup and surrounding chambers are rectangular in cross section.

These methods are controlled to produce a range of emissivity, absorption coefficients at each of the opposing surfaces of the radiant heating process in a preferred range of 0.8 to 0.97.

Tests have shown this radiant heating approach to be just as effective as prior art liquid external baths without difficulties of such external baths and to reduce duration of achieving target high temperatures and to increase reliability of attaining and maintaining highest target temperatures.

Other features and advantages of the present invention will be apparent from the following detailed description of various embodiments taken in conjunction with the accompanying drawings in which:

### BRIEF DESCRIPTION OF THE DRAWINGS

FIG. 1 is an isometric view of an instrument in accordance with an embodiment of the invention;

FIG. 2 is a top view of the instrument of FIG. 1, showing the section cuts at lines 3-3 and 4-4 to be shown in FIGS. 3 and 4, respectively;

FIGS. 3A and 3B are sectional view of the instrument along line 3-3 of FIG. 2, with a rheometer unit outside and inside, respectively, of a heating unit;

FIG. 4 is a sectional view of the instrument along line 4-4 of FIG. 2, with the rheometer unit inserted into the heating unit; and

FIG. 5 is a block diagram of electronic controls of the heating unit in accordance with an embodiment of the invention.

### DETAILED DESCRIPTION

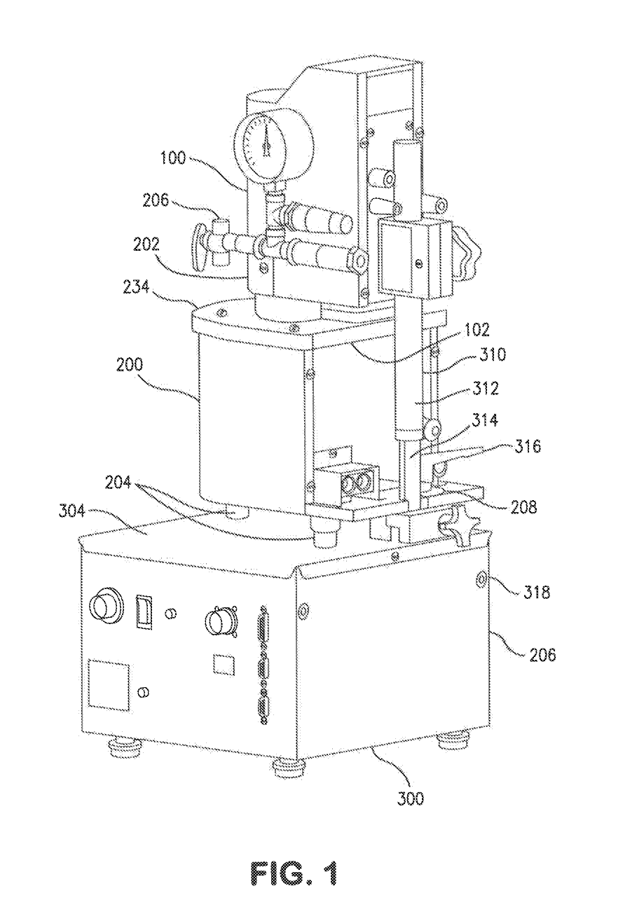

One embodiment of the rheometer instrument of the present invention shown in FIG. 1 comprises a rheometer unit immersed in a heating unit 200 mounted on a base assembly 300. The rheometer unit has multiple alignment pins (e.g. 102), entering alignment ports (e.g. 202) of the heating unit. The heating unit in turn has multiple spacer legs (e.g. 204) resting on a heat shield top 304 of the base assembly. A heat shield 208 of the heating unit protects coolant inlet/outlet ports described below.

The base assembly contains power supply and signal processing elements of the instrument. Conduits 207 for coolant water or other fluid are provided in the heating unit 200 with ports at 206 and the fluid is supplied through the ports to the heating unit by a user. A vertical slide assembly 310 is provided. It has an axially slidable part 312 and fixed part 314 mounted on a stand which can be seated on the base unit or on a lab table or floor and is constructed to provide stable support. Other terms of holding slide assembly can be provided. The slidable part carries the rheometer unit out of the heating unit up out of the rheometer or lower the rheometer unit down into it as shown in FIG. 1 and has an alignment handle 316 for adjusting angular orientation of the rheometer unit to align its alignment pins 102 with heating ports 202 as the rheometer unit is lowered to the heating for enabling proper insertion of a sensing portion of the rheometer unit (riot shown in FIG. 1) into the heating unit. A clamp assembly 318 locks the rheometer unit in position once fully aligned and lowered. The heating unit has its own covering radiant heat shield 234. A pressurization assembly 206 is part of the rheometer unit. The rheometer unit has a temperature sensor 110 of resistance temperature detector (RTD) type at the base of its probe near the sample cup bottom which can be used in conjunction with heating element of the heating unit to stabilize temperature of the sample fluid in a highly responsive manner. The rotation torsion element assembly 108 includes a torsion wire 109.

The rheometer unit per se is substantially similar to the Brookfield Engineering Laboratories Inc, long extant (in the U.S. and abroad) model PVS rheometer.

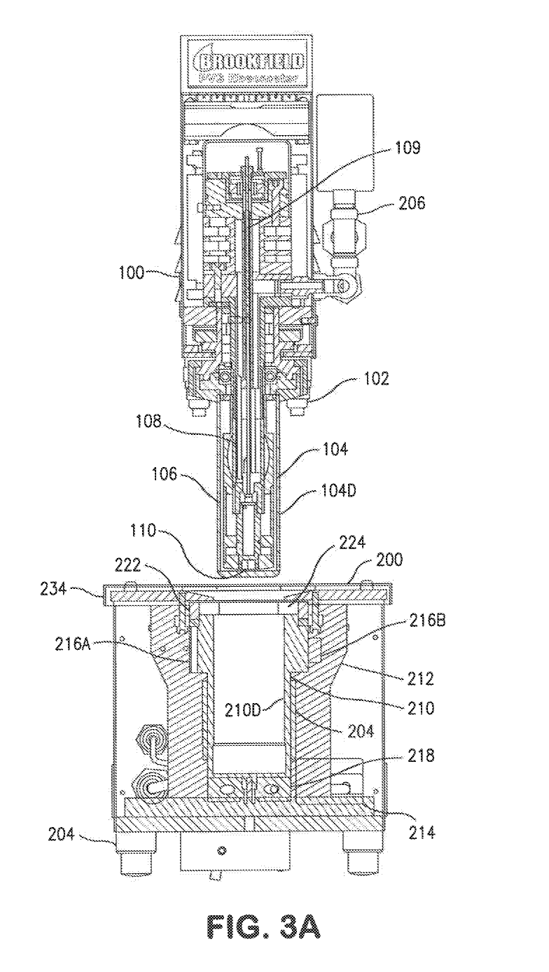

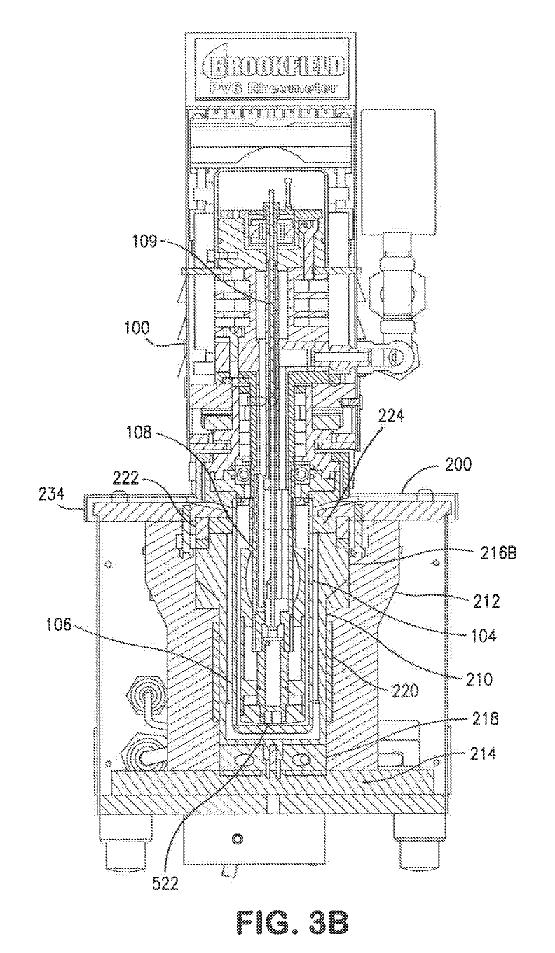

FIG. 3A shows the rheometer unit 100 and heating unit 200 separated, each in cross section. The rheometer unit comprises a sample cup 104 for containing a pressurized fluid sample 106. Within the cup is a spindle assembly 108. In this embodiment the cup is rotated by a rotation assembly while the spindle assembly is grounded. But in other embodiments the reverse case can be true or both cup and spindle assembly can rotate. Rotations from 1 to 100 or even 1000 rpm can be used for various rheometer designs, typically 1 to 50.

The heating unit 200 comprises a brass heat chamber 210 surrounded by an insulator cylinder 212 and seated on an insulating block 214 is a heating block 216 with a temperature sensor 216A and an overtemperature switch 216B (e.g. a bi-metallic element) is mounted to the base. A cooling block 218 with internal conduits for coolant liquid enables quickly cooling the heating unit between tests.

A ceramic insulator 222 is provided. A felted thermoset fibrous resin (e.g. DuPont's Kevlar® brand aramid fiber) 224 is provided to keep the heated air between the bath chamber and sample cup from escaping too quickly.

Instead of having a surrounding liquid bath as in conventional practice to heat the cup entirely by conduction from the bath, the present invention uses radiation as a replacement. The structure for effecting radiant heating includes a heater band 220 (preferably made of mica), an emissive coating on the interior diameter 210D of the heat block's central well. In turn the outer diameter 104D of the sample cup has an absorptive coating.

The emissive coating silicone based high temperature flat Hack paint.

The absorptive coating is the well known polymer matrix high temperature ceramic coating system exemplified by Cerakote™ brand coating of NIC Industrial Co., White River, Oreg. and applied as a matte/black ceramic coating.

The heater band rated at 500 watts is made of mica.

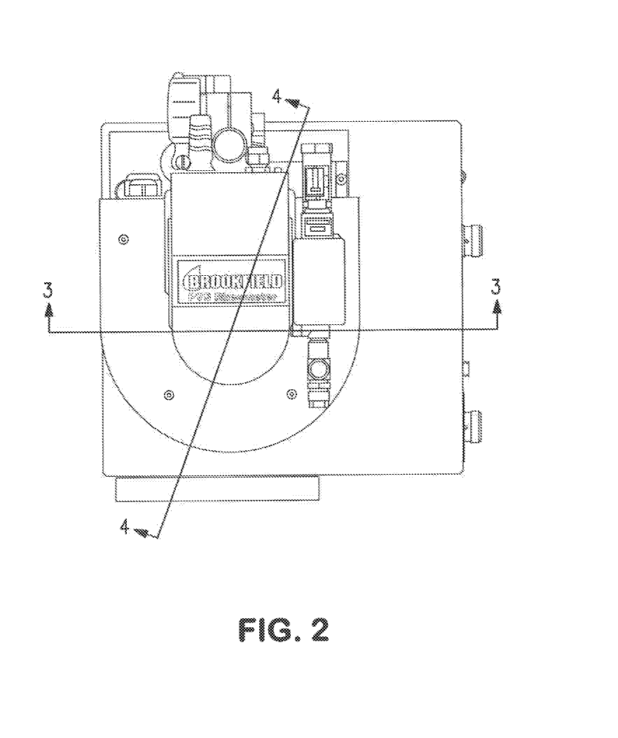

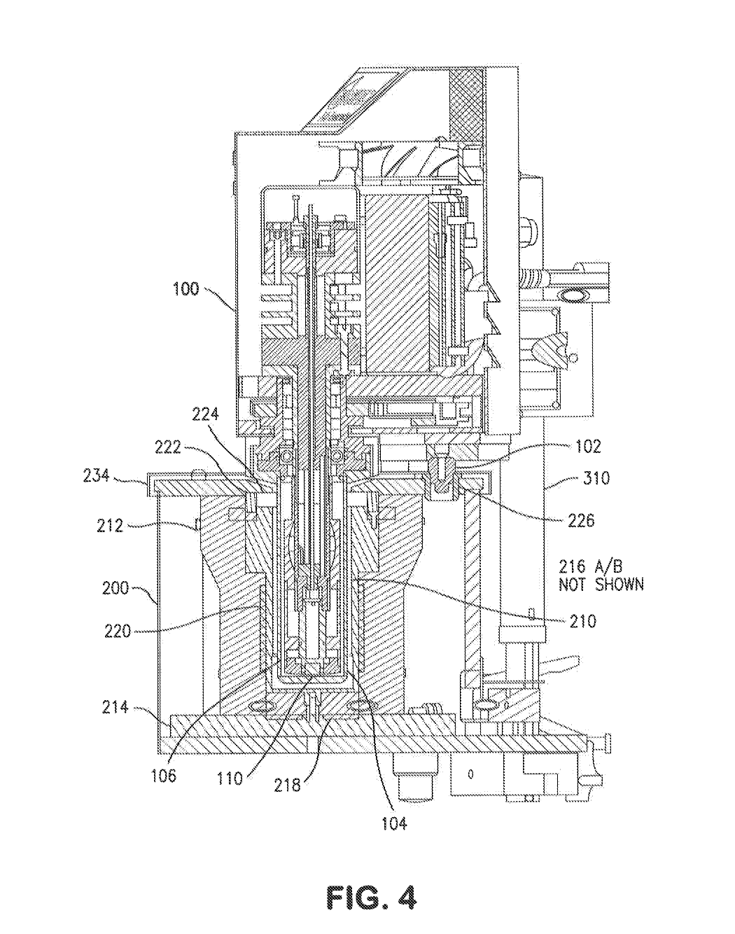

FIGS. 3B and 4 show the rheometer unit inserted into the heating unit in two sectioned views, cut as indicated, respectively, by arrows 3-3 and arrows 4-4 in FIG. 2. FIG. 4 corresponds essentially to FIG. 3B and the section cut of FIG. 4 is offset by about 45′ to intercept an alignment pin and show part of the vertical adjustment assembly 310, as shown in FIG. 2. A smooth surfaced bushing 226 is provided (e.g., typically made of DuPont's Teflon® brand fluoropolymers). FIG. 2 is a top view showing the section at lines for FIGS. 3B and 4.

Testing of the radiant heating unit shows the necessity for the heat emitting/absorbing coatings on the sample cup exterior surface and heating block cup well inner surface. This emissivity coefficients of both should be in the 0.8-0.97 range.

Tests were conducted at 5, 10 and 250 rpm of cup rotation for such surfaces as (a) unpainted and (b) both painted with black emissive/absorptive coatings as described above in an effort to achieve cup/sample temperature of 260° C. in a reasonable time through use of the mica heater and heating block with the heater powered at 500 watts. The results were as shown in Table 1 below:

TABLE 1

| | | Start Temperature | | Elapsed Time¹ |
|---|---|---|---|---|
| Sample | RPM | (° C.) | End Temp ° C. | (minutes) |
| (a) | 5 | 16.2 | 235 | (i) |
| (a) | 10 | 24.3 | 238 | (ii) |
| (a) | 250 | 21.8 | 260 | 75 |
| (b) | 5 | 28.2 | 260 | 40 |
| (b) | 10 | 21.5 | 260 | 34 |
| (b) | 250 | 21 | 260 | 26 |

¹(i) aborted at 235° C. after 110 minutes and (ii) aborted at 238° C. after 96 minutes and (ii) aborted at 238° C. after 90 minutes

In the above testing and in a commercial scale embodiment the temperature of the heating block was and is accurate from room temperature up to 340° C. to maintain an adequate heat flux to reliably maintain selected sample temperatures.

Sensing of temperature should be done in commercial units both at the sample fluid and in the bath heat chamber of the heating unit.

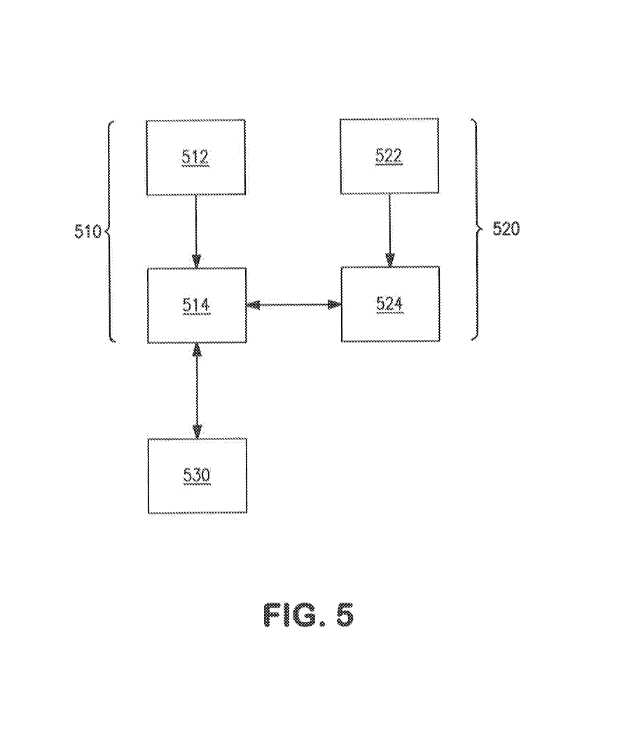

FIG. 5 is a block diagram of electronic controls of the heating unit including electronics module 510 of the rheometer unit with a sensing head 512 and control board 514, module 520 of the heating unit, including its resistance temperature detecting device (RTD) 522 fixed in the heating unit, and a computer 530 essentially as in standard form of those used in long extant rheometers such as the BEL PVS model using BEL's Rheovision™ brand software described at http://www.brookfieldengineering.com/products/software/rheovision.asp. The computer uses a proportional integral derivative (PID) control loop feedback algorithm with a 0 to 340 degree range of temperature control and typical (PID) self correcting/learning features for system control.

As noted above the instrument heater is at a higher temperature vs. target sample temperature, e.g. 340° C. heater temperature vs, a 260° C. target sample heat temperature. Measurements of sample and heating block temperature are used in the PID control or sample temperature near the target temperature (e.g. 260° C.) to attain a product reach to the target temperature and minimize over-shoot and upon reaching target temperatures to maintain minimum if any deviation by raising, lowering the level of supplied heating. Between tests quick cooling can be expedited by the coolant fluids passed in and out of the rheometer unit via ports 206 and conduits 207.

It is thus seen that a radiant heating approach is feasible and can achieve all that is achieved in prior art baths without the difficulties of an external liquid bath for heating (weight, volume, orientation sensitivity, etc.)

It will now be apparent to those skilled in the art that other embodiments, improvements, details, and uses can be made consistent with the letter and spirit of the foregoing disclosure and within the scope of this patent, which is limited only by the following claims, construed in accordance with the patent law, including the doctrine of equivalents.

1. A rheometer instrument for containing a fluid whose rheological properties are to be measured, comprising a rheometer unit with a sample cup, a heating unit with a cup chamber to receive said sample cup at a close spacing of opposed surfaces of the cup outer surface and a chamber wall inner surface, and means for heating the chamber to a temperature in excess of a target temperature of the fluid to be tested to enable radiant heating of the cup from a heat source within the heating unit, the heat being transmitted as radiant heat flux from the chamber inner wall and absorbed at the cup outer surface thereby heating the fluid in the sample cup, and means for controlling the heating.

2. The instrument of claim 1 comprising temperature measurement means for the chamber.

3. The instrument of claim 2 further comprising means for measuring temperature of the sample fluid utilized in the control of heating.

4. The instrument of claim 1 with coatings on the opposing surfaces of the chamber and cup wall with emissivity coefficient of each surface at or in excess of 0.8.

5. A heating unit for rheometers comprising a chamber for receiving a fluid sample container with a container-receiving chamber in the unit constructed and arranged to present an emissive surface in closely spaced relation to a container surface and means for heating the container within the chamber by radiant heating from the chamber surface to the container.

6. The unit of claim 5 wherein the radiant heating is a heat flux from the chamber surfaces substantially surrounding the container.

7. A heating unit for a rheometer instrument comprising a heat block including a hollow chamber for insertion of a sample fluid cup, a heater for the block, the interior surface of the chamber having a high emissivity coefficient of at least 0.8, means for heating the block to a temperature higher than the target temperature of fluid in a cup inserted in the chamber, means for detecting temperature at the cup or of the fluid therein, and control means to effect a heating of the cup and fluid by radiant heating from the chamber inner surface.

8. The heating unit of claim 7 in combination with a sample cup, the cup having an outer surface emissivity/absorption coefficient of at least 0.8 and being constructed and arranged to fit within the chamber with its outer surface in closely spaced opposition to the chamber unit wall.
